(19) United States
(12) Patent Application Publication
(10) Pub. No.: US 2012/0312625 A1
(43) Pub. Date: Dec. 13, 2012

(54) Hydraulic Power Steering System

(76) Inventor: Jeffrey E. Tipton, Gettysburg, PA (US)

(21) Appl. No.: 13/578,709

(22) PCT Filed: Feb. 27, 2010
(86) PCT No.: PCT/US2010/025698

§ 371 Date: Aug. 13, 2012

(51) Int. Cl. B62D 5/083; F16K 21/04; F15B 9/08

(52) U.S. Cl. 180/441; 91/368; 137/511

(57) ABSTRACT

A hydraulic power steering system for a ground vehicle includes a closed-center control valve, a fluid supply line and an exhaust line extending into the control valve and first and second motor lines extending out of the control valve to a fluid motor. An additional flow line extends from each motor line to the exhaust line and contains a check valve that allows flow in the flow line only towards the motor line. The additional flow lines enable manual steering in the event fluid supply is lost without leakage loss during normal on center operation.

### FIELD OF THE INVENTION

The invention relates to hydraulic power steering systems for motor vehicles, and in particular, to closed-center type power steering systems.

### BACKGROUND OF THE INVENTION

Trucks and other ground vehicles have a hydraulic power steering system that provides power assist in turning the steerable wheels of the vehicle.

A conventional hydraulic power steering system flows high-pressure power steering fluid to a fluid motor that has a piston within a closed hydraulic cylinder. The piston divides the cylinder into motor chambers on opposite sides of the piston. The piston is connected to a steering linkage that moves the steerable wheels along a steering stroke. The piston is axially movable in the cylinder between opposite ends of a piston stroke to actuate the steering linkage and move the steerable wheels along their steering stroke to the left or right.

To initiate a turn, the driver turns a steering wheel to cause the steerable wheels to move in the desired turning direction. The steering wheel is connected to a control valve that connects one of the motor chambers to an inlet line that flows high-pressure power steering fluid into the fluid motor and connects the other motor chamber to an exhaust line that flows fluid from the fluid motor to a discharge reservoir. The fluid pressure in the high-pressure chamber generates power assist moving the piston from its centered position in the cylinder (corresponding to the centered, straight-ahead position of the steerable wheels along their steering stroke) towards the low-pressure motor chamber. This actuates the steering linkage, moving the steerable wheels in the turning direction.

Power steering systems have conventionally used an engine-driven pump to continuously flow power steering fluid to an open-center control valve. The open-center control valve continuously flows the power steering fluid received from the pump, even when the wheels are in a straight-ahead position and are not being turned.

Today, however, an increasing number of motor vehicles use energy-saving power steering systems that utilize a closed-center control valve to control flow to the fluid motor. A closed-center valve shuts off the flow of high-pressure fluid into the control valve when the valve is in a centered condition and the wheels straight ahead and not being turned. The control valve allows high-pressure fluid to flow through the valve and to the fluid motor only when the control valve is away from its centered position for turning.

Because a steering system utilizing a closed-center valve does not require a continuous flow of high-pressure fluid, power steering fluid is provided to the control valve when needed from a gas-pressurized accumulator. A motor (which motor is typically an electric motor, gasoline motor, or diesel motor) intermittently supplies power steering fluid to the accumulator from a reservoir on an as-needed basis when the fluid volume or fluid pressure in the accumulator drops below some minimum level.

Both open-center and closed-center control valves have two valving members that move relative to one another to control flow to the fluid motor. The valving members move from a centered condition to an off-center condition to initiate a turn, causing high-pressure fluid to flow into the high-pressure chamber and to flow out of the low-pressure chamber with movement of the piston. One valving member is connected to the steering wheel and the other valving member is connected to the piston through an actuating screw or rack.

If the control valve is disconnected from the flow or source of power steering fluid, power steering assist is lost. The control valve has stop members that mechanically connect the valving members to enable manual steering if power steering is lost. Manual steering transmits torque applied to the steering wheel to the piston to move the piston and steer the wheels.

The power steering system must enable piston movement during manual steering by allowing steering fluid to flow into one motor chamber and out the other motor chamber when power steering assist is lost. If fluid cannot flow into and out of the fluid motor chambers, the piston is “hydraulically locked” and cannot move despite the efforts of the driver to manually steer the vehicle.

Open-center control valves utilize a check valve placed between the inlet line and the exhaust line to prevent hydraulic lock if power steering assist is lost. FIG. 1 illustrates a conventional power steering system 10 having an open-center control valve 12 controlled by a steering wheel 14. High-pressure power steering fluid is continuously provided by a pump 16 and flows into the open-center control valve 12 through the inlet line 18. Steering fluid flows out of the control valve 12 to a discharge or exhaust reservoir 20 through an exhaust line 22. Motor lines 24 and 26 extend from the control valve to the left and right motor chambers 27a, 27b of the fluid motor 28. The chambers 27 are divided by motor piston 29. A communication line 30 extends between the inlet line 18 and the exhaust line 22. A check valve 32 is in the communication line 30, the check valve 32 permitting flow through the communication line 30 only towards the inlet line 18.

FIG. 1 illustrates the power steering system 10 in straight-ahead operation. The control valve 12 connects the inlet line 18 with both motor chambers 27a, 27b and the exhaust line 22. Both motor chambers 27a, 27b are filled with pressurized fluid and the piston 29 is stationary. In the figures lines carrying high-pressure fluid are shown in thick solid lines and the lines flowing fluid to exhaust are shown in thick dashed lines. Fluid delivered by the pump 16 flows continuously through the inlet line 18, through the control valve 12, and to the reservoir 20 through the exhaust line 22 in a counterclockwise direction as shown in the figure and indicated by solid arrows.

The fluid pressure communicated to the communication line 30 from the inlet line 18 closes the check valve 32. There is leakage flow indicated by open arrow 34 through the check valve 32. Leakage through the check valve 32 does not adversely affect straight-ahead operation of the power steering system due to the continuous flow and recirculation of power steering fluid from the pump 16.

FIG. 2 illustrates normal operation of the power steering system 10 to turn the steerable wheels in one direction. The control valve 12 is actuated to fluidly connect the inlet line 18 with the motor line 24 and to fluidly connect the motor line 26 with the exhaust line 22, forcing the motor piston to move to the right. The high-pressure fluid from the inlet line 18 closes the check valve 32 and prevents flow (other than leakage flow) through the communication line 30. Leakage through the check valve 32 (the leakage flow is represented by an open arrow adjacent the valve 32) does not adversely impact turning performance of the steering system 10 because the leakage flow is small as compared to the fluid flow to and from the fluid motor 28.

FIG. 3 illustrates manual operation of the power steering system due to loss of power steering assist. A break or obstruction 36 in the inlet line 18 prevents power steering fluid from flowing into the control valve 12. The steering wheel has been turned and the piston is forced to move to the right (indicated by the arrow 38), the control valve 12 now in the off-center condition shown in the figure. Piston movement forces fluid to flow out of the right motor chamber, through the right motor line 26 and into the exhaust line 22 (shown as the thick line in the figure). Piston movement also generates suction that flows fluid from the inlet line 18, through the left motor line 24 and into the left motor chamber (shown in thick dashed lines in the figure). The fluid pressure in the exhaust line 22 and the suction in the inlet line 18 opens the check valve 32 and enables fluid flow from the exhaust line 22 to the inlet line 18 through the communication line 30 to complete the flow circuit, with the arrows in FIG. 3 showing the direction of flow through the circuit.

Enabling manual steering in a closed-center power steering system can also be accomplished in like manner by placing a check valve in a communication line extending from the exhaust line to the inlet line. FIG. 4 illustrates a power steering system 40 with a closed-center control valve 12 (components of the closed-center power steering system 40 that correspond to the open-center power steering system 10 are numbered with the same reference numerals as used in FIGS. 1-3). The pump 16 is an electric pump that supplies power steering fluid to an accumulator 42 that stores the working fluid and supplies the fluid on demand through the inlet line 18. When the control valve 12 is in its centered position shown in FIG. 3, the inlet line 18 is blocked from communicating with the fluid motor 28 and so there is no flow out of the accumulator 34.

FIG. 5 illustrates normal operation of the power steering system 40, which is similar to the operation of the power steering system 10 shown in FIG. 2. The control valve 12 is actuated to fluidly connect the inlet line 18 with the motor line 24 and to fluidly connect the motor line 26 with the exhaust line 22, forcing the motor piston to move to the right. The fluid lines carrying high-pressure fluid from the accumulator 42 to the fluid motor 28 are shown in thick solid lines and the lines flowing fluid from the fluid motor 28 to exhaust are shown in thick dashed lines. The high-pressure fluid line closes the check valve 32 and prevents the flow of fluid through the communication line 30.

FIG. 6 illustrates manual operation of the power steering system 40 caused by the break or obstruction 36 in the inlet line. The steering wheel has been turned to force the piston to move to the right, placing the control valve 12 in the off-center condition shown in the figure. Manual operation of the power steering system 40 is the same as already described for the power steering system 10.

Referring back to FIG. 4, the figure illustrates straight-ahead operation of the closed-center power steering system 40. Leakage flow 34 through the communication line 30 enables some power steering fluid to flow to exhaust before reaching the control valve 12. Unlike the open-center steering system 10, such leakage 34 in a closed-center steering system depletes the stored fluid in the accumulator 42. The accumulator 42 must be recharged more often, reducing energy savings and increasing system wear.

Thus there is a need for an improved hydraulic power steering system that is especially suitable for closed-center steering systems that enables manual steering but reduces or essentially eliminates such leakage losses.

### SUMMARY OF THE INVENTION

The invention is an improved hydraulic power steering system that is especially suitable for use with closed-center steering systems. The improved power steering system essentially eliminates the additional leakage found in conventional closed-center steering systems during straight-ahead driving while still enabling manual power steering operation in the event of loss of power steering assist.

A power steering system in accordance with the present invention includes a fluid motor having opposite hydraulic motor chambers, first and second motor lines connected to respective motor chambers to flow working fluid to or from each motor chamber, a fluid supply line or inlet line extending from a source of high-pressure working fluid and an exhaust line extending from an exhaust. A valve arrangement having relatively movable valving surfaces controls the flow of fluid to and from the fluid motor and selectively connects the inlet line with the first or second motor line and connects the exhaust line with the other of the first or second motor line. A first communication line extends from the first motor line to the exhaust line and a second communication line extends from the second motor line to the exhaust line. A check valve is in each of the first and second communication lines, each check valve configured to permit flow through its communication line only towards the motor line.

By extending the communication lines from the motor lines to the exhaust line, the communication lines see high-pressure power steering fluid only when the motor line is connected to the supply line or input line. When the valving arrangement defines a closed-center valve, the motor lines are disconnected from the input line during normal straight-ahead driving. This eliminates the presence of high-pressure power steering fluid during straight-ahead driving that might otherwise leak past the check valves to exhaust.

When power steering assist is lost, the check valves enable one of the communication lines to fluidly connect a motor line with the exhaust line to define a flow circuit flowing fluid into and out of the fluid motor to avoid hydraulic lock while closing the other communication line.

In a preferred embodiment of the invention the valving arrangement includes cooperating sleeve and core members relatively movable with respect to one another. The communication lines are preferably formed entirely within one or both of the sleeve and core members.

In a particularly preferred embodiment the cooperating sleeve and core members are rotatable about an axis of rotation, the core member surrounded by the sleeve member. The communication lines are formed as radial bores extending from the outer surface of the core member into the core member.

Other objects and features of the invention will become apparent as the description proceeds, especially when taken in conjunction with the accompanying 13 drawing sheets illustrating four embodiments of the invention.

### BRIEF DESCRIPTION OF THE DRAWINGS

FIG. 1 is a hydraulic circuit of a conventional open-center power steering system for a motor vehicle having steerable wheels, the hydraulic circuit illustrating the power steering system in the straight-ahead steering condition;

FIG. 2 is the hydraulic circuit of FIG. 1 illustrating a turn being made using power-steering assist;

FIG. 3 is the hydraulic circuit of FIG. 1 illustrating manual steering of the vehicle;

FIG. 4 is a hydraulic circuit similar to the circuit shown in FIG. 1 but illustrating the power steering system with a closed-center valve;

FIG. 5 is the hydraulic circuit of FIG. 4 illustrating a turn being made using power-steering assist;

FIG. 6 is the hydraulic circuit of FIG. 4 illustrating manual steering of the vehicle;

FIG. 7 is a hydraulic circuit for a closed-center power steering system in accordance with the present invention for a motor vehicle having steerable wheels, the circuit illustrating the power steering system in the straight-ahead steering condition;

FIG. 8 is the hydraulic circuit of FIG. 7 illustrating a turn being made using power-steering assist;

FIG. 9 is the hydraulic circuit of FIG. 7 illustrating manual steering of the vehicle;

FIG. 10 illustrates a closed-center power steering system having an axial-type control valve in accordance with the present invention for a motor vehicle having steerable wheels, the power steering system in the straight-ahead steering condition;

FIG. 11 is the power steering system shown in FIG. 10 illustrating a turn being made using power assist;

FIG. 12 is the power steering system shown in FIG. 10 illustrating manual steering of the vehicle;

FIG. 13 illustrates a closed-center power steering system having a different axial-type control valve in accordance with the present invention for a motor vehicle having steerable wheels, the power steering system in the straight-ahead steering condition;

FIG. 14 is the power steering system shown in FIG. 13 illustrating a turn being made using power assist;

FIG. 15 is the power steering system shown in FIG. 13 illustrating manual steering of the vehicle;

FIG. 16 illustrates a rotary-type control valve in accordance with the present invention;

FIG. 17 is a power steering system incorporating the rotary control valve shown in FIG. 16, the control valve shown in a sectional view taken along lines 17-17 of FIG. 16; and

FIG. 18 is the power steering system shown in FIG. 17, the control valve shown in a sectional view taken along lines 18-18 of FIG. 16.

### DETAILED DESCRIPTION OF THE INVENTION

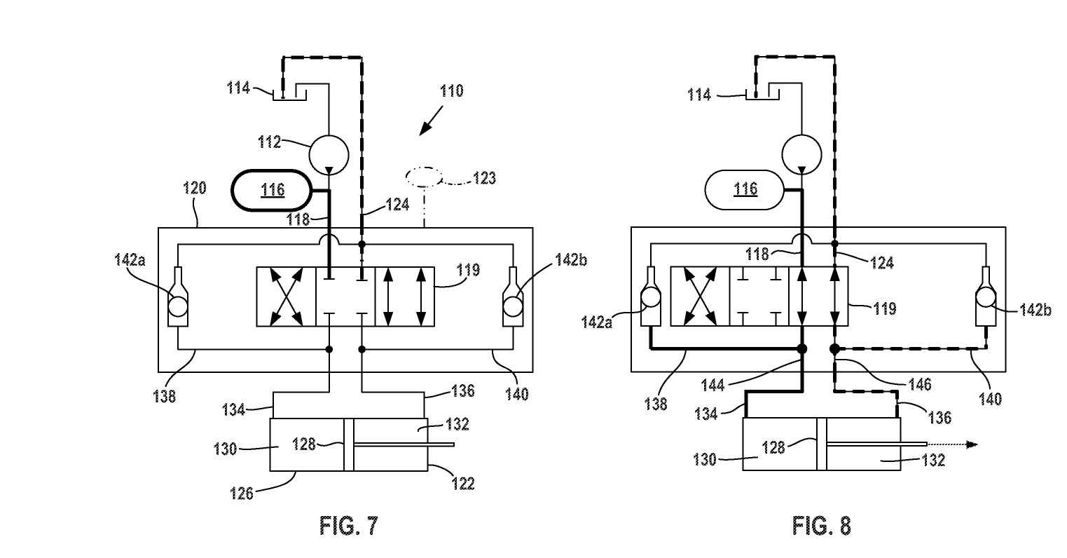

FIG. 7 illustrates a hydraulic power steering system 110 in accordance with the present invention to move the steerable wheels of a ground vehicle.

The power steering system 110 includes an electric pump 112 that intermittently supplies power steering fluid from a reservoir 114 to a gas-pressurized accumulator 116. A first inlet line or supply line 118 fluidly connects the accumulator 116 with the conventional closed-center valving members 119 of a closed-center control valve 120. The control valve 120 controls the flow of fluid to a fluid motor 122 in a conventional manner in response to a steering input. The steering input is represented by a steering wheel 123 connected to the control valve 120, it being understood that steering input may be provided by other input mechanisms, such as steer-by-wire, known in the motor vehicle art. An exhaust line 124 fluidly connects the valving members 119 with the reservoir 114 and returns the fluid to the reservoir.

The fluid motor 122 includes a hydraulic cylinder 126 and a double-acting piston 128 axially movable in the cylinder 126. The piston 128 is connected to the steerable wheels of the vehicle by a steering linkage (not shown) in a conventional manner, with movement of the piston moving the steerable wheels along a steering stroke. The piston 128 sealingly divides the cylinder 126 into a left cylinder chamber or motor chamber 130 and a right cylinder chamber or motor chamber 132. A left motor line 134 connects the left motor chamber 130 and the valving members 119 and a right motor line 136 fluidly connects the right motor chamber 132 with the valving members 119.

Extending from each motor line 134, 136 to the exhaust line 124 is a communication line 138 or 140. Located in the communication lines 138, 140 are check valves 142a, 142b respectively, each check valve 142 shown schematically as a ball-type check valve. The check valve 142 permits flow through its communication line 138 or 140 only in the direction towards the motor line 134 or 136.

FIG. 7 illustrates the power steering system 110 in its centered condition with the piston 128 centered in the cylinder and representing a centered position of the vehicle steerable wheels. The valving arrangement 119 disconnects the inlet line 118 from the motor lines 134, 136 and so no fluid flows out of the accumulator 116. Any leakage from the inlet line 118 to the exhaust line 14 must be through the valving elements 119, and conventional valving elements 119 can achieve a very low leakage rate. Because the motor lines 134, 136 are disconnected from the inlet line 118 there is effectively no leakage from the motor lines 134, 136 through the communication lines 138, 140.

As illustrated schematically in FIG. 7 the communication lines 138, 140 are preferably contained entirely within the control valve 120.

FIG. 8 illustrates operation of the power steering system 110 in response to steering input that urges the piston 128 to the right as shown in the figure.

The valving members 119 fluidly connect the left motor line 134 and the input line 118, forming a high-pressure line that fluidly connects the accumulator 116 and the left motor chamber 130. The valving members 119 fluidly connect the right motor line 136 with the exhaust line 124, forming an exhaust line that fluidly connects the right motor chamber 132 with the exhaust reservoir 114.

High-pressure fluid in the left motor line 134 is transmitted through the left communication line 138, closing the check valve 142a and preventing fluid flow through the left communication line 138. Leakage of high pressure fluid through the check valve 142a during the steering event is insignificant compared to the flow of fluid into the left motor chamber 130.

The right communication line 140 is fluidly in parallel with the exhaust line 124. Flow through the right communication line 140 tends to close the check valve 142b, but exhaust flow to the discharger reservoir is essentially unaffected by the operating condition of the check valve 142b.

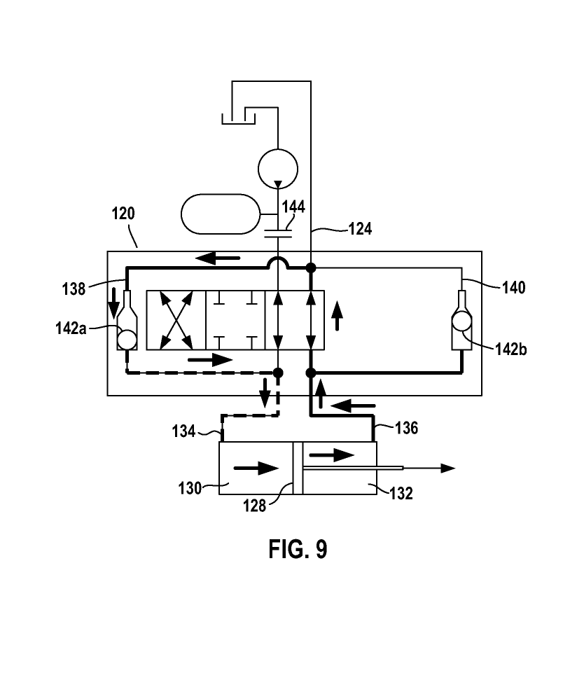

FIG. 9 illustrates manual operation of the power steering system 110, with loss of power steering assist caused by a break or interruption 144 of the flow of high-pressure power steering fluid into the control valve 120. The steering wheel has been turned to force the piston 128 to move to the right, placing the control valve 120 in the off-center condition shown in the figure. Piston movement forces fluid to flow out of the right motor chamber 132 and into the right motor line 136, through the valving 119, and into the exhaust line 134. Attempted flow through right communication line 140 closes the check valve 142b.

Piston movement also generates suction that flows fluid from the left motor line 134 into the left motor chamber 130. The fluid pressure in the portion of the left communication line 138 from the exhaust line 124 and the suction in the left motor line 134 opens the check valve 142a, completing the flow circuit between the right and left motor chambers and enabling fluid flow from the exhaust line 124 to the left motor line 134. Fluid flows in a counter-clockwise direction as viewed in FIG. 9 from the right motor chamber 132 and into the left motor chamber 130, with the arrows in FIG. 9 indicating the direction of flow through the circuit.

If manual steering forces the piston 128 to the left as viewed in FIG. 9, the valving 119 interconnects the left motor line 134 with the exhaust line 124. Fluid is forced out of the left motor chamber 130 through the left motor line 134, closing the left check valve 142. The fluid flows from the left motor line 134 across the valving 119, and into the exhaust line 124. The fluid returns to the right motor chamber 132 through the right motor line 136. The check valve 142b opens to complete the flow circuit through the right communication line 140. Fluid flows in a clockwise direction as viewed in FIG. 9 from the left motor chamber 130 and into the right motor chamber 132.

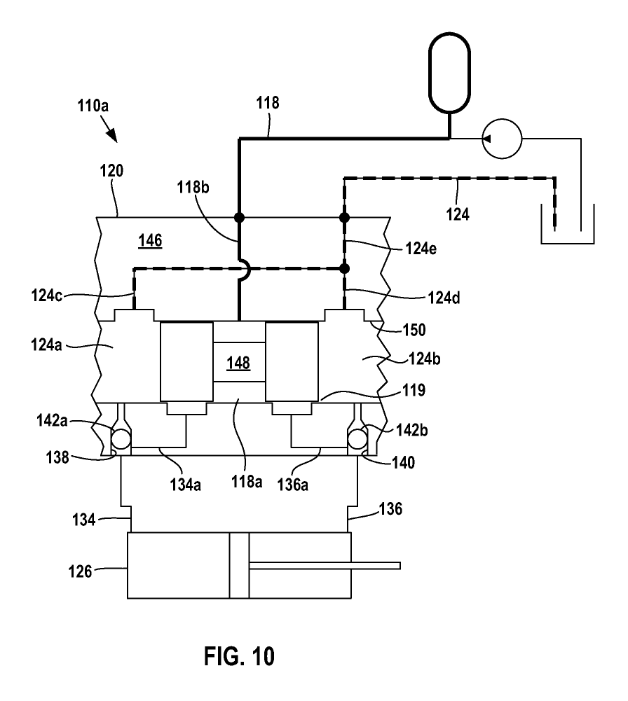

FIGS. 10-19 illustrate power steering systems 110 with different types of otherwise conventional control valves modified to incorporate the left and right communication lines in accordance with the present invention. The selected control valves used to illustrate the invention are not intended to limit the application of the invention to just those control valves, but to illustrate that conventional control valves can be readily adapted to use the dual communication line of the present invention. System components that are the same as those shown in the FIG. 9 hydraulic circuit are identified with the same reference numerals.

FIG. 10 illustrates a power steering system 110a having an axial-type closed-center control valve 120. The control valve 120 includes cooperating cylindrical sleeve member 146 and core member 148 that have cooperating control surfaces that define the valving arrangement or valving members 119 in a conventional manner. FIG. 10 illustrates the power steering system 110a in a straight-ahead steering condition, with the valving elements 119 blocking flow from the inlet line 118 to the fluid motor 126. The core member 148 is formed as a spool valve that is axially movable in the bore 150 of the sleeve member 146.

The portion of the exhaust line 124 within the control valve 120 includes two chamber portions 124a, 124b defined by the wall of the bore 150 and located on opposite sides of the spool valve 148, and exhaust line branch portions 124c, 124d extending from respective chamber 124a, 124b to a common exhaust line portion 124e. The inlet line 118 includes an annular chamber 118a defined between the wall of the bore wall 150 and a reduced-diameter portion of the spool valve 148, and an inlet line portion 118b extending from the inlet chamber 118a to the outer surface of the sleeve 146.

The portions 134a, 136a of the left and right motor lines 134, 136 within the control valve 120 extend through the cylinder wall of the sleeve 146, opening into the bore 150.

Left and right communication lines 138, 140 extend from respective motor line portions 134a, 136a, and open into the exhaust line 124 at respective exhaust chambers 124a, 124b. Each check valve 142 in the communication line 138 or 140 is a ball-type check valve having a reduced-width line portion opening into the exhaust chamber.

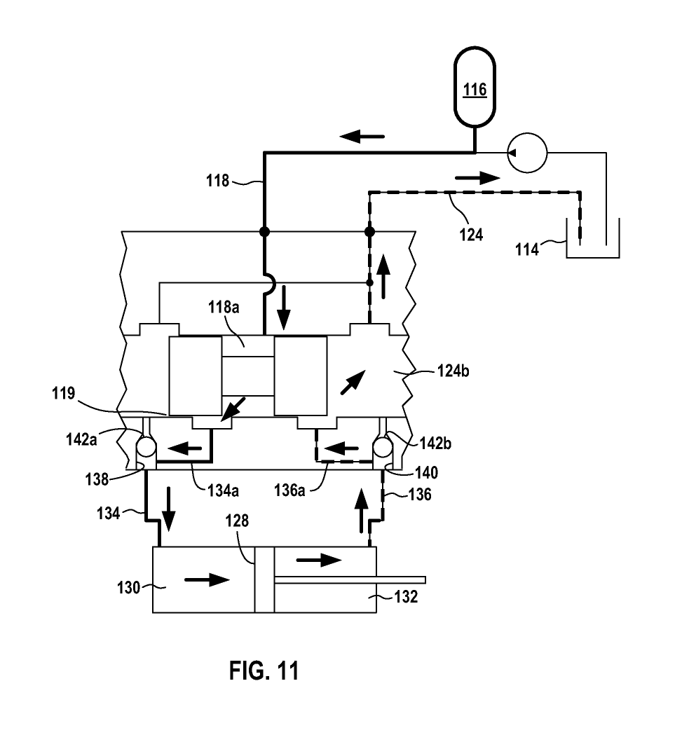

FIG. 11 illustrates operation of the power steering system 110a in response to steering input that urges the piston 128 to the right as shown in the figure.

The valving members 119 fluidly connect the left motor line 134 and the input line 118 in a conventional manner by interconnecting the inlet chamber 118a with the motor line portion 134a, forming a high-pressure line that fluidly connects the accumulator 116 and the left motor chamber 130. The valving members 119 fluidly connect the right motor line 136 with the exhaust line 124 by interconnecting the right motor line portion 136a with the exhaust chamber 124b, forming an exhaust line that fluidly connects the right motor chamber 132 with the exhaust reservoir 114.

High-pressure fluid in the left motor line 134 is transmitted through the left communication line 138, closing the check valve 142a and preventing fluid flow through the left communication line 138. Leakage of high pressure fluid through the check valve 142a during the steering event is insignificant compared to the flow of fluid into the left motor chamber 130.

The right communication line portion 140a is fluidly in parallel with the right motor line 136a. Flow through the right communication line 140 tends to close the check valve 142b, but exhaust flow to the discharge reservoir 114 is essentially unaffected by the operating condition of the check valve 142b.

If the steering wheel is turned to force the piston 128 to the left as shown in FIG. 11, the valving elements 119 will interconnect the right motor chamber 132 with the inlet line 118 and interconnect the left motor chamber 130 with the exhaust line 124. High pressure in the left motor line 136 will close the check valve 142b in the right communication line 140. The left communication line 142a will be fluidly in parallel with the left motor line portion 134a connected to exhaust.

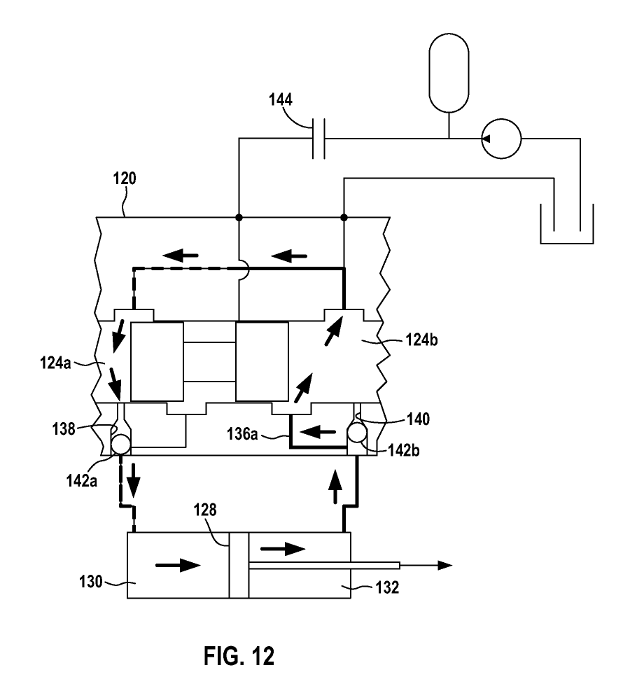

FIG. 12 illustrates manual operation of the power steering system 110a, with loss of power steering assist caused by a break or interruption 144 of the flow of high-pressure power steering fluid into the control valve 120. The steering wheel has been turned to force the piston 128 to move to the right, placing the control valve 120 in the off-center condition shown in the figure. Left motor line 136 is fluidly connected with the exhaust line 124 at the exhaust chamber 124b, and the right motor line 134 is fluidly connected to the exhaust line 124 at the exhaust chamber 124a. Fluid flows in a counter-clockwise direction as viewed in FIG. 12 from the right motor chamber 132, through the right motor line 136 and into the exhaust line 124, and from the exhaust line 124 to the left motor line 134 and into the left motor chamber 130. The arrows in FIG. 12 indicate the direction of flow from and to the motor chambers 132, 130 through the circuit.

If manual steering forces the piston 128 to the left as viewed in FIG. 12, the valving 119 interconnects the left motor line 134 with the exhaust line 124. Fluid is forced out of the left motor chamber 130 through the left motor line 134, closing the left check valve 142a. The fluid flows from the left motor line 134 across the valving 119, and into the exhaust line 124. The fluid returns to the right motor chamber 132 through the right motor line 136. The check valve 142b opens to complete the flow circuit through the right communication line 140. Fluid flows in a clockwise direction as viewed in FIG. 12 from the left motor chamber 130 and into the right motor chamber 132.

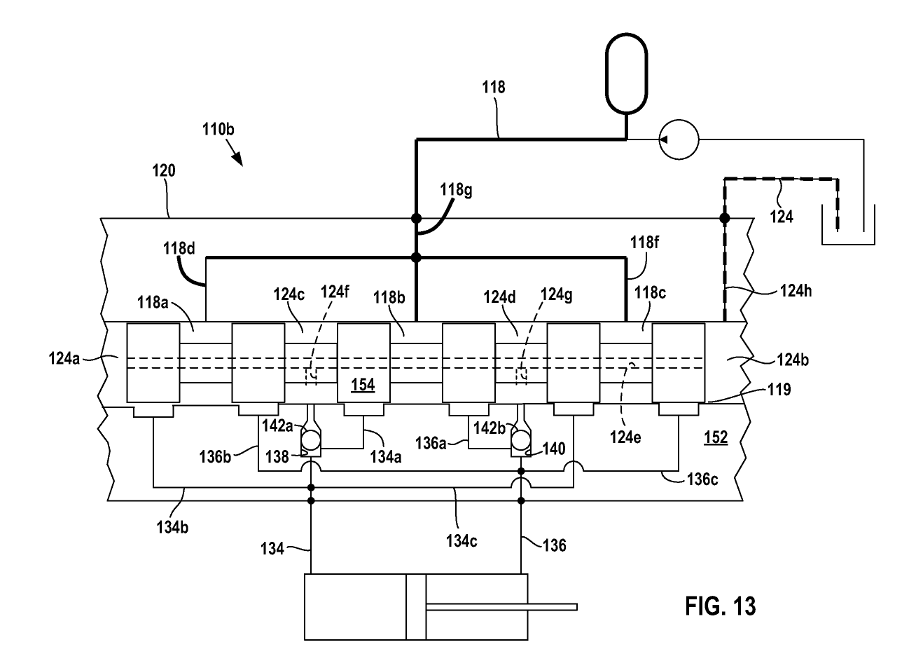

FIG. 13 illustrates a power steering system 110b also having an axial-type closed-center control valve 120. The control valve 120 includes cooperating cylindrical sleeve member 152 and core member 154 that have cooperating control surfaces that define the valving arrangement or valving members 119 in a conventional manner. FIG. 13 illustrates the power steering system 110b in a straight-ahead steering condition, with the valving elements 119 blocking flow from the inlet line 118 to the fluid motor 126. The valve members 152 and 154 are similar to the valve members 148, 150 but define three valving stations along the length of the control valve rather than a single valving station as shown in system 110a.

The portion of the exhaust line 124 within the control valve 120 includes two chamber portions 124a, 124b defined by the interior wall of the sleeve 136 and located on opposite sides of the spool valve 154, interior chamber portions 124c, 124d, a central through-bore 124e extending through the axial length of the spool valve 154 and fluidly connecting the chamber portions 124a, 124b, and radial bores 124f and 124g that fluidly connect the internal chamber portions 124c, 124d with the bore 124c. A common exhaust line portion 124h extends from the chamber portion 124b to the outside of the sleeve 152.

The inlet line 118 includes annular inlet chambers 118a, 118b, and 118c defined between the interior sleeve wall and a respective reduced-diameter portion of the spool valve 154, and respective inlet line portions 118d, 118e, 118f that extend from a common input line portion 118g and discharge into the respective inlet chambers 118a, 118b, 118c.

The left and right motor lines 134, 136 within the control valve 120 each bifurcate into three motor line portions 134a, 134b, 134c and 136a, 136b, and 136c that open into the cylindrical bore of the sleeve 152.

Left and right communication lines 138, 140 extend from respective motor line portions 134a, 136a, and open into the exhaust line 124 at respective exhaust chambers 124c, 124d. Each check valve 142 in the communication line 138 or 140 is a ball-type check valve having a reduced-width line portion opening into the exhaust chamber.

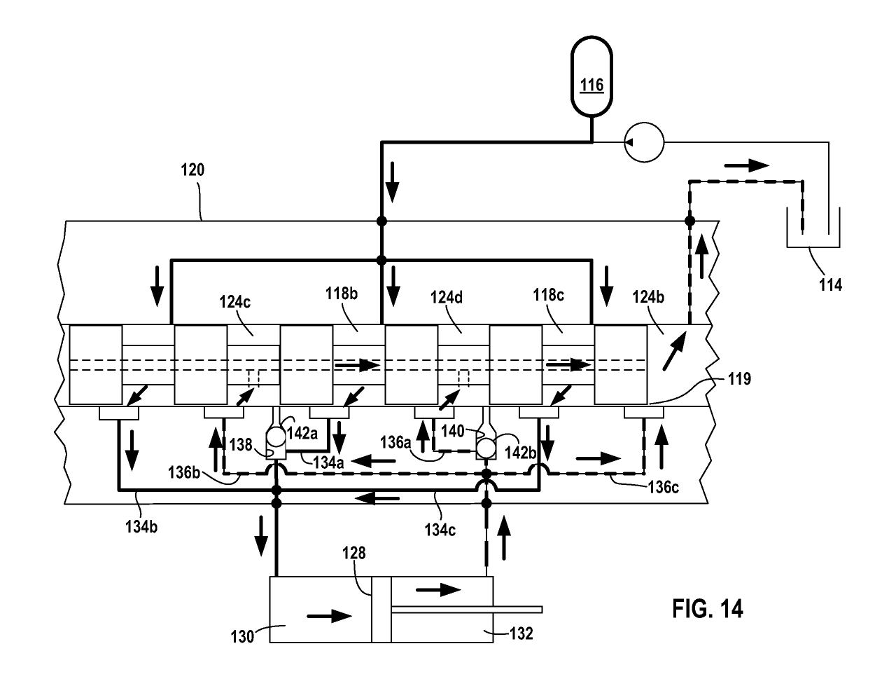

FIG. 14 illustrates operation of the power steering system 110b in response to steering input that urges the piston 128 to the right as shown in the figure.

The valving members 119 fluidly connect the left motor line portions 134a, 134b, and 134c with respective inlet chambers 118a, 118b, 118c in a conventional manner, forming a high-pressure line that fluidly connects the accumulator 116 and the left motor chamber 130. The valving members 119 fluidly connect the right motor line portions 136a, 136b, 136c with the exhaust line chambers 124d, 124c, 124b forming an exhaust line that fluidly connects the right motor chamber 132 with the exhaust reservoir 114.

High-pressure fluid in the left motor line portion 134a is transmitted through the left communication line 138, closing the check valve 142a and preventing fluid flow through the left communication line 138. Leakage of high pressure fluid through the check valve 142a during the steering event is insignificant compared to the flow of fluid into the left motor chamber 130.

The right communication line 140 is fluidly in parallel with the left motor line portion 136a. Flow through the right communication line 140 tends to close the check valve 142b, but exhaust flow to the discharge reservoir is essentially unaffected by the operating condition of the check valve 142b.

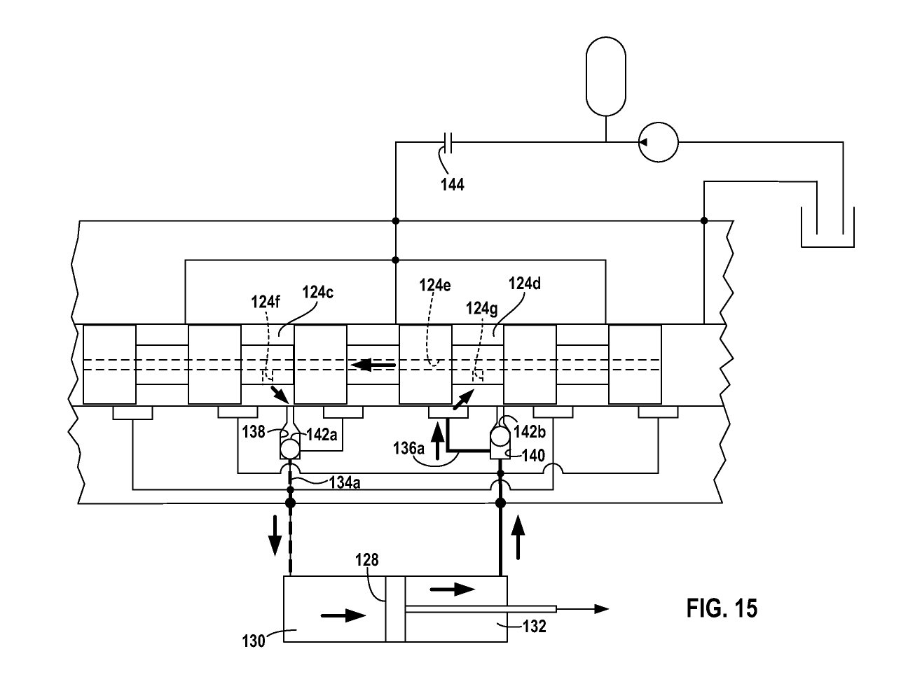

If the steering wheel is turned to force the piston 128 to the left as viewed in FIG. 15, the valving elements 119 will interconnect the right motor chamber 132 with the inlet line 118 and interconnect the left motor chamber 130 with the exhaust line 124. High pressure in the left motor line 136 will close the check valve 142b in the right communication line 140. The left communication line 142a will be fluidly in parallel with the left motor line portion 134a connected to exhaust.

FIG. 15 illustrates manual operation of the power steering system 110b, with loss of power steering assist caused by a break or interruption 144 of the flow of high-pressure power steering fluid into the control valve 120. The steering wheel has been turned to force the piston 128 to move to the right, placing the control valve 120 in the off-center condition shown in the figure. Fluid flows in a counter-clockwise direction as viewed in FIG. 15 from the right motor chamber 132 out the right motor line 136 and into the left motor chamber 130 from the right motor line 134. Flow out of the motor line portion 136a is into the exhaust chamber 124d and flow from the exhaust chamber 124c is into the left communication line 138 and to the left motor line portion 134a. Exhaust line portion 124e fluidly connects the two exhaust chambers 124d, 124c through bores 124f, 124g. The arrows in FIG. 15 indicate the direction of flow from the motor chamber 132 to the motor chamber 130 through the circuit.

If manual steering forces the piston 128 to the left as viewed in FIG. 15, the valving 119 interconnects the left motor line 134 with the exhaust line 124. Fluid is forced out of the left motor chamber 130 through the left motor line 134, closing the left check valve 142. The fluid flows from the left motor line 134 across the valving 119, and into the exhaust line 124. The fluid returns to the right motor chamber 132 through the right motor line 136. The check valve 142b opens to complete the flow circuit through the right communication line 140. Fluid flows in a clockwise direction as viewed in FIG. 15 from the left motor chamber 130 and into the right motor chamber 132.

As illustrated in FIG. 15, only one set or pair of communication lines 138, 140 used with one of the valving stations is needed to create a fluid circuit connecting the left and right motor chambers for manual steering. It is not necessary to supply a pair of communication lines 138, 140 for each valving station in a multi-station valving arrangement.

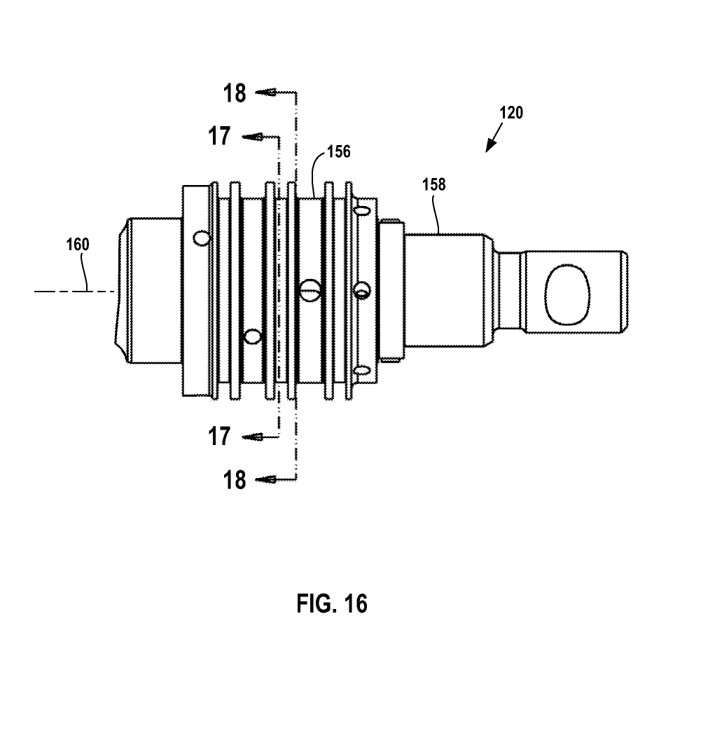

FIGS. 16-18 illustrate a power steering system 110c having a rotary type closed-center control valve 120. The control valve 120 includes cooperating cylindrical sleeve member 156 and core member 158 that extend axially along an axis of rotation 160. The core member 158 is relatively rotatable with respect to the sleeve member 156 to actuate cooperating land and groove control surfaces that define the valving arrangement or valving members 119 in a conventional manner. The illustrated control valve 120 has three valving stations distributed circumferentially around the valve to distribute flow into and out of the fluid motor 126, but only the valving station associated with the communication lines will be described.

The portion of the exhaust line 124 within the control valve 120 includes a central bore 124a extending axially in the core member 158 and circumferentially-spaced radial bores 124b, 124c that extend from the bore through the radial thickness of the core member 158. The features of the exhaust line within the control valve 120 are conventional and so will not be described in further detail.

The portion of the inlet line 118 within the control valve 120 includes a radial bore 118a extending through the radial thickness of the outer sleeve 156 that is in fluid connection with an axial groove 118b formed on the outside of the valve core 158. These features are also conventional and so will not be described in further detail.

The left and right motor lines 134, 136 within the control valve 120 each include a respective radial bore 134a, 136b extending through the radial thickness of the outer sleeve 156 that is in fluid communication with a respective axial groove 134b, 136b formed on the outside of the valve core 158. The grooves 134b, 136b are circumferentially spaced from inlet groove 118b. These features are also conventional and so will not be described in further detail.

Left and right communication lines 138, 140 are formed in the valve core 158 as radial bores extending from the outside of the valve core 158 to the exhaust line bore 124a. The radial communication lines 138, 140 are axially spaced from the radial exhaust lines 124b, 124c, and only one set of communication lines 138, 140 is provided. The openings of the communication lines 138, 140 on the outer surface of the valve core 158 are radially aligned with the respective motor line grooves 134b, 136c to fluidly communicate each motor line 134, 136 with the exhaust line 124. Each check valve 142 in the communication line 138, 140 has a reduced-width portion opening into the exhaust line 124 that cooperates with a ball to prevent flow through the communication line towards the exhaust line 124 while permitting flow from the exhaust line towards the motor line.

Turning the steering wheel left or right during normal system operation causes the valving arrangement 119 to interconnect the inlet groove 118b with one of the motor line grooves 134b or 136b and interconnect the other motor line grooves 136b or 134b with one of the exhaust line bores 124c or 124b in a conventional manner. High-pressure fluid in the pressurized motor line groove 134b or 136b is communicated to the check valve 142 in the fluid communication line 138 or communication line 140 connected to the inlet motor line 118 to close the check valve 142. The other fluid communication line 138 or communication line 140 extends in parallel with the other motor line groove 134b or 136b connected to exhaust 124 as previously described.

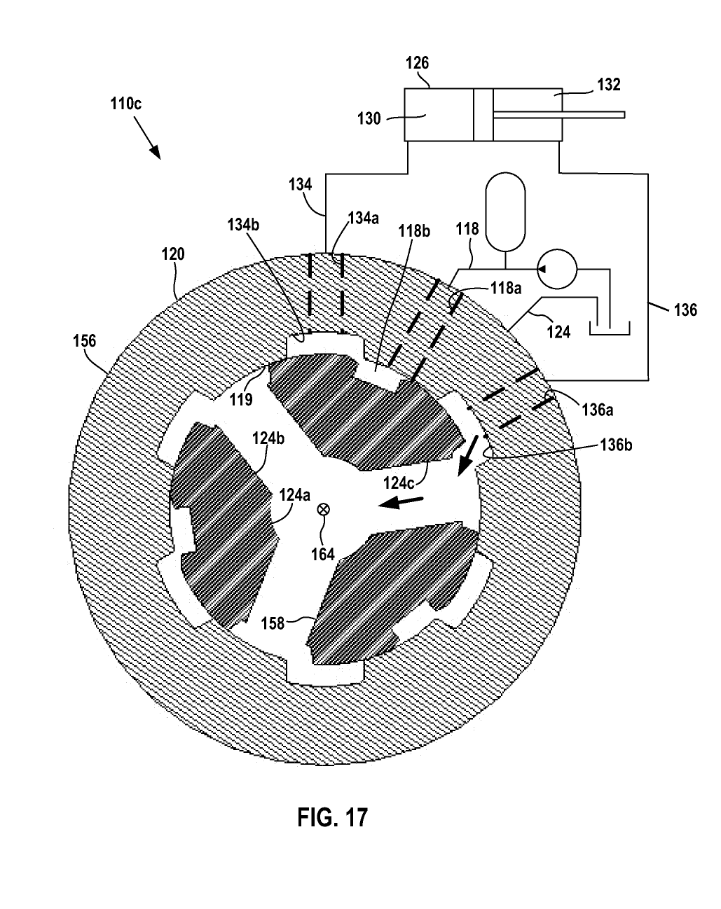

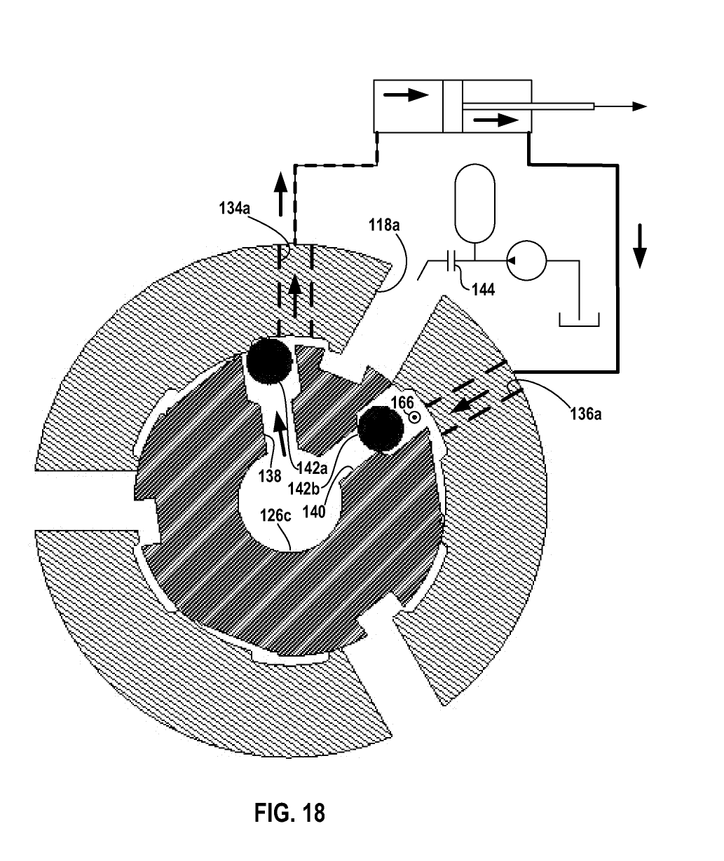

FIGS. 17 and 18 illustrate manual operation of the power steering system 110c, with loss of power steering assist caused by a break or interruption 144 (see FIG. 18) of the flow of high-pressure power steering fluid into the control valve 120. The steering wheel has been turned to force the piston 128 to move to the right, placing the control valve 120 in the off-center condition shown in the figures. Arrows indicate the direction of fluid flow.

Movement of the piston 128 forces fluid out of the right motor chamber 132 into the right motor line 136, and sucks fluid into the left motor chamber 130 through the left motor line 134. The valve arrangement 119 interconnects the right motor chamber 132 with the right motor bore 136a and right motor groove 136b and interconnects the left motor line groove 134b and left motor bore 134a with the left motor chamber 130. Fluid flows into the left motor groove 136b, closing the check valve 142 in the left communication line 140. The fluid flows axially in the left motor groove 136a to the exhaust bore 126c. This axial flow in the motor groove 136a is represented by the arrow 166 extending out of the drawing sheet in FIG. 18.

The left communication line 138 is connected to the left motor groove 134b, and suction generated in the left motor chamber 130 causes the check valve 142a to open, permitting flow from the exhaust bore 124c, through the left communication line 138 and into the left motor groove 134b to complete the flow circuit between the right and left motor chambers 132, 130. Fluid flows axially in the circuit in the exhaust bore 126c to fluidly communicate the exhaust bore 126c with the left communication line 138. This flow is represented by the arrow 164 extending into the drawing sheet in FIG. 17.

If manual steering forces the piston 128 to the left as viewed in FIG. 9, the valving 119 interconnects the left motor line 134 with the exhaust line 124. Fluid is forced out of the left motor chamber 130 through the left motor line 134, closing the left check valve 142. The fluid flows from the left motor line 134 across the valving 119, and into the exhaust line 124. The fluid returns to the right motor chamber 132 through the right motor line 136. The check valve 142b opens to complete the flow circuit through the right communication line 140. Fluid flows in a clockwise direction as viewed in FIG. 9 from the left motor chamber 130 and into the right motor chamber 132.

If manual steering forces the piston 128 to the left as viewed in FIGS. 17 and 18, the valving 119 interconnects the left motor line 134 with the exhaust line 124. Fluid is forced out of the left motor chamber 130 into the left motor groove 134b, closing the left communication line check valve 142a. Fluid flows axially in the motor groove 134b to the exhaust bore 124b, axially in the bore 124b to the right communication line 140, the flow urging the check valve 142b open. Flow through the right communication line 140 is discharged into the right motor groove 136b and flows through the right motor bore 136a and into the right motor chamber 132.

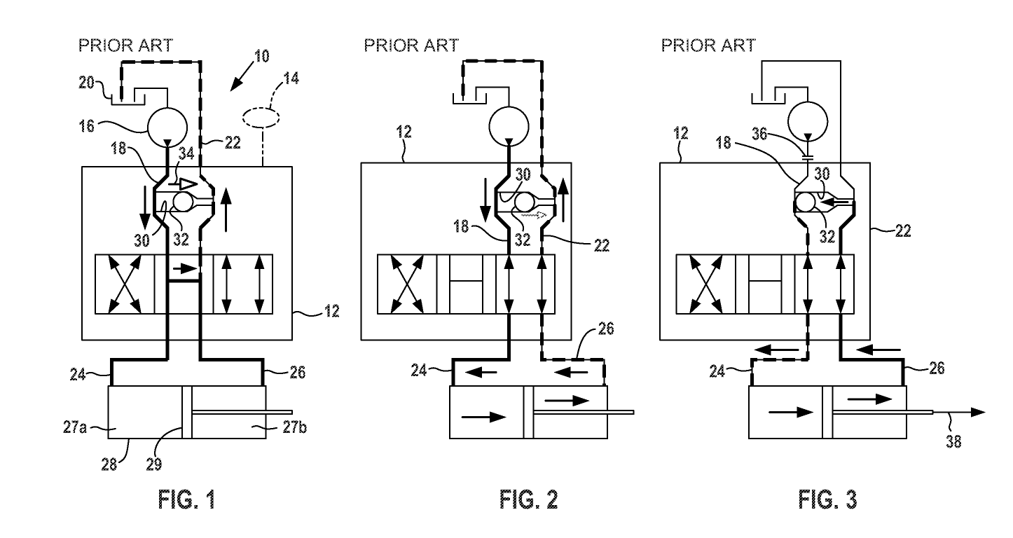

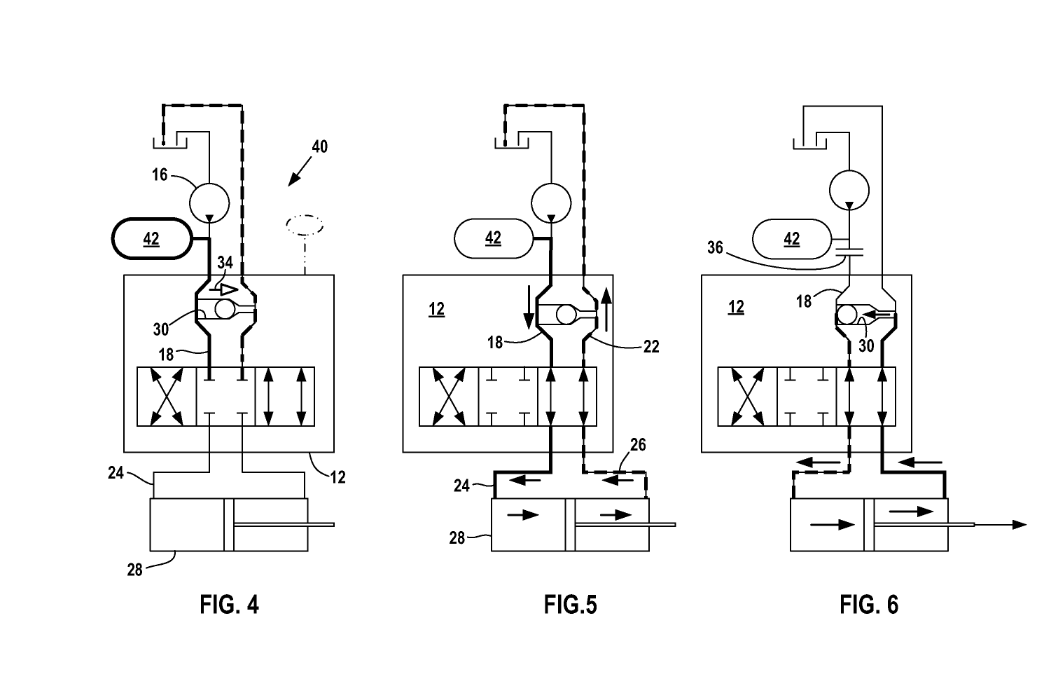

The illustrated power steering systems 110 have a closed-center valving arrangement 119. The present invention can also be adapted for use with an open-center valving arrangement 119 such as that shown in FIG. 1.

While I have illustrated and described preferred embodiments of my invention, it is understood that this is capable of modification, and I therefore do not wish to be limited to the precise details set forth, but desire to avail myself of such changes and alterations as fall within the purview of the following claims.

1. A hydraulic power steering system for turning the steerable wheels of a motor vehicle, the power steering system comprising:
a fluid motor having opposite hydraulic motor chambers;
first and second motor lines connected to respective motor chambers to flow working fluid to or from each motor chamber;
a fluid supply line extending from a source of high-pressure working fluid and an exhaust line extending from an exhaust;
a valve arrangement having relatively movable valving surfaces to control the flow of fluid to and from the fluid motor, the valve arrangement configured to selectively connect the fluid supply line with the first or second motor line and connect the exhaust line with the other of the first or second motor line;
a first communication line extending from the first motor line to the exhaust line and a second communication line extending from the second motor line to the exhaust line; and
a check valve in each of the first and second communication lines, each check valve configured to permit flow through its communication line only towards the motor line.

2. The power steering system of claim 1 wherein the valve arrangement comprises cooperating sleeve and core members relatively rotatable about an axis.

3. The power steering system of claim 2 wherein the sleeve and core members define axially extending grooves therein and the core member comprises an axially extending bore, each motor line comprising a respective groove and the exhaust line comprising said bore, each communication line extending from the respective motor groove to the bore.

4. The power steering system of claim 3 wherein the core member comprises a radial bore extending from the axial bore to a radially outer surface side of the core member, the radial bore forming a portion of the exhaust line, the radial bore axially spaced along the core member from the first and second communication lines.

5. The power steering system of claim 4 wherein each check valve comprises a ball in the communication line containing the check valve.

6. The power steering system of claim 5 wherein each communication line comprises a reduced width portion opening into the axial bore.

7. The power steering system of claim 1 wherein the valving arrangement comprises cooperating sleeve and core members relatively translatable along a longitudinal axis.

8. The power steering system of claim 7 wherein the sleeve is a cylindrical member having a bore and a wall surrounding the bore, the core member in the bore of the sleeve, each motor line having an opening in the bore and extending through the sleeve wall, the exhaust line comprising at least one portion of the bore, and each communication line extending from the respective motor line to the at least one portion of the bore.

9. The power steering system of claim 8 wherein the valving arrangement disconnects the inlet line from the fluid motor for straight-ahead steering.

10. A power steering control valve for selectively interconnecting opposite motor chambers of a fluid motor with a source of high-pressure fluid and an exhaust, the control valve comprising:
an inlet line configured to be connected to the fluid source, an exhaust line configured to be connected to the exhaust, a first motor line to be connected to one motor chamber, a second motor line to be connected to the other motor chamber, a valve arrangement by which the inlet line and exhaust line can be selectively placed in fluid communication with the first motor line or the second motor line to generate a fluid pressure difference between the motor chambers, a first communication line fluidly connecting the first motor line and the exhaust line, a second communication line fluidly connecting the second motor line and the exhaust line, a respective valve in each of the first and second communication lines, the valve operable to permit flow through the communication line containing the valve only towards the motor line.

11. The control valve of claim 10 wherein the control valve is a closed-center control valve.

12. The control valve of claim 10 wherein the control valve is a rotary valve comprising cooperating sleeve and core members relatively rotatable about an axis.

13. The control valve of claim 12 wherein the sleeve and core members define axially extending grooves therein and the core member comprises an axially extending bore, each motor line comprising a respective groove and the exhaust line comprising said bore, each communication line extending from the respective motor groove to the bore.

14. The control valve of claim 13 wherein the core member comprises a radial bore extending from the axial bore to a radially outer surface side of the core member, the radial bore forming a portion of the exhaust line, the radial bore axially spaced along the core member from the first and second communication lines.

15. The control valve of claim 13 wherein each valve comprises a ball in the communication line containing the valve.

16. The control valve of claim 15 wherein each communication line comprises a first line portion opening into the motor line and a reduced width portion opening into the bore, the reduction in width of the communication line defining a valve seat for the ball.

17. The control valve of claim 13 wherein the control valve is a closed-center control valve.

18. The control valve of claim 10 wherein the control valve is an axial valve comprising cooperating sleeve and core members relatively translatable along a longitudinal axis.

19. The control valve of claim 18 wherein the sleeve is a cylindrical member having a bore and a wall surrounding the bore, the core member in the bore of the sleeve, each motor line having an opening in the bore and extending through the sleeve wall, the exhaust line comprising at least one portion of the bore, and each communication line extending from the respective motor line to the at least one portion of the bore.

20. The control valve of claim 19 wherein the control valve is a closed-center control valve.

21. The control valve of claim 10 wherein the fluid motor comprises a double-acting piston and cylinder, the motor chambers on opposite sides of the piston.

22. A ground vehicle comprising:
one or more steerable wheels movable for turning the vehicle to the left or right, a power steering apparatus mechanically connected to the one or more steerable wheels for power assist in moving the one or more steerable wheels;
the power steering apparatus comprising a source of high-pressure working fluid, a fluid motor having a double-acting piston movable in a hydraulic cylinder and respective motor chambers on opposite sides of the piston, the piston operatively connected to the one or more steerable wheels for conjoint movement of the piston and the one or more steerable wheels, a first motor line connected to one motor chamber and a second motor line connected to the other motor chamber, the motor lines for flowing fluid to and from the fluid motor, an inlet line connected to the fluid source, an exhaust line connected to an exhaust reservoir, a valve arrangement by which the inlet line and exhaust line are selectively placed in fluid communication with the first motor line or the second motor line to generate a fluid pressure difference between the motor chambers, a first communication line fluidly connecting the first motor line and the exhaust line, a second communication line fluidly connecting the second motor line and the exhaust line, a respective valve in each of the first and second communication lines, the valve operable to permit flow through the communication line containing the valve only towards the motor line.

23. The ground vehicle of claim 22 wherein the source of high-pressure working fluid comprises a pump and accumulator, the inlet line connected to the accumulator to flow fluid from the accumulator, and the valving arrangement is a closed-center arrangement that disconnects the inlet line from the fluid motor during straight-ahead steering.

24. The ground vehicle of claim 22 wherein the valving arrangement comprises a sleeve member and a core member, the sleeve and core members movable with respect to one another for operating the valving members, one of the sleeve and core members operatively connected to the piston, and a mechanical stop connection that limits relative motion of the sleeve member with respect to the core member.

25. The ground vehicle of claim 24 wherein the sleeve and core members define a control valve, the first and second communication lines contained entirely within the control valve.

26. The ground vehicle of claim 25 wherein the control valve is a rotary control valve.
